(19) United States
(12) Patent Application Publication
(10) Pub. No.: US 2026/0339970 A1
(43) Pub. Date: Oct. 29, 2026

(54) INFORMATION PROCESSING PROGRAM, METHOD, AND APPARATUS

(71) Applicant: Fujitsu Limited, Kawasaki-shi (JP)

(72) Inventor: Takuya TAKAGI, Kawasaki (JP)

(73) Assignee: Fujitsu Limited, Kawasaki-shi (JP)

(21) Appl. No.: 19/704,118

(22) Filed: Jun. 10, 2026

Related U.S. Application Data
(63) Continuation of application No. PCT/JP2023/044282, filed on Dec. 11, 2023.

(51) Int. Cl. G06F 16/2458; G06F 16/901

(52) U.S. Cl. CPC G06F 16/2465; G06F 16/9024

(57) ABSTRACT

An information processing apparatus includes a processor that executes a procedure. The procedure includes: acquiring graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge; selecting, in the graph information, a shortest path including the undirected edge, the shortest path being a path from a causal variable among the two variables of interest to a result variable among the two variables of interest via a variable other than the two variables of interest; enumerating patterns in which the undirected edge included in the shortest path is set to a directed edge under a constraint that no cycle is generated between the variables connected by the directed edge; and repeating the selecting the shortest path and the enumerating patterns until no undirected edge remains in the enumerated patterns.

### CROSS-REFERENCE TO RELATED APPLICATION

This application is a continuation application of International Application No. PCT/JP2023/044282, filed Dec. 11, 2023, the disclosure of which is incorporated herein by reference in its entirely.

### FIELD

The disclosed technology relates to an information processing program, an information processing method, and an information processing apparatus.

### BACKGROUND

In order to grasp what kind of causal relationship exists between a plurality of events, a causal graph expressing a causal relationship between events in a directed acyclic graph (DAG) is presented to a user. For example, a technology for outputting one optimal causal graph among causal graphs obtained by various algorithms for investigating causal relationships has been proposed.

### Cited Literature

### Non Patent Literature

[Non Patent Literature 1] Alessio Zanga, Elif Ozkirimli, Fabio Stella, “A Survey on Causal Discovery: Theory and Practice,” International Journal of Approximate Reasoning 151 (2022) 101-129.

### SUMMARY

According to an aspect of the embodiments, a non-transitory recording medium storing a program executable by a computer to perform information processing comprising: acquiring graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge; selecting, in the graph information, a shortest path including the undirected edge, the shortest path being a path from a causal variable among the two variables of interest to a result variable among the two variables of interest via a variable other than the two variables of interest; enumerating patterns in which the undirected edge included in the shortest path is set to a directed edge under a constraint that no cycle is generated between the variables connected by the directed edge; and repeating the selecting the shortest path and the enumerating patterns until no undirected edge remains in the enumerated patterns.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a causal directed acyclic graph (DAG).

FIG. 2 is a diagram for describing an output of a conventional causal DAG.

FIG. 3 is a diagram for describing an output of a causal DAG in the present embodiment.

FIG. 4 is a functional block diagram of an information processing apparatus according to the present embodiment.

FIG. 5 is a diagram illustrating an example of input graph information.

FIG. 6 is a diagram illustrating an example of an output screen in which causal DAGs are enumerated.

FIG. 7 is a block diagram illustrating a schematic configuration of a computer that functions as the information processing apparatus.

FIG. 8 is a flowchart illustrating an example of an information processing routine.

FIG. 9 is a diagram for describing information processing in the present embodiment.

FIG. 10 is a diagram illustrating a transition of information in a table format.

FIG. 11 is a diagram illustrating a transition of information in a table format.

FIG. 12 is a diagram illustrating an example of an output screen in a first modified example.

FIG. 13 is a diagram for describing information processing in a second modified example.

### DESCRIPTION OF EMBODIMENTS

Hereinafter, an example of an embodiment according to the disclosed technology will be described with reference to the drawings.

In the present embodiment, a case where all possible causal graphs are enumerated for the purpose of knowing an influence of a variable A representing a certain event on a variable Y representing another event, that is, knowing all relationships between the variable A and the variable Y will be described. Note that all the relationships between the variable A and the variable Y include a relationship in which the variable A affects another variable, and the another variable affects the variable Y.

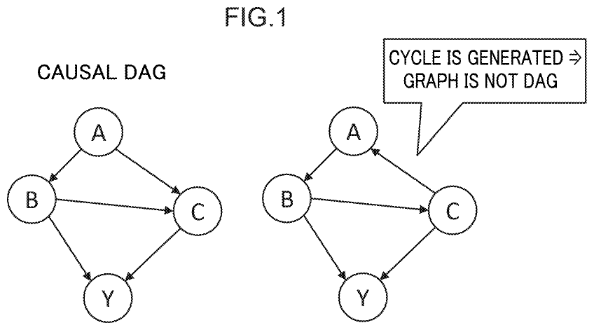

Furthermore, in the present embodiment, a graph (hereinafter, referred to as “causal directed acyclic graph (DAG)”) in which the causal relationship is expressed in the form of a DAG by connecting variables with an edge represented by an arrow from a variable representing a cause to a variable representing a result is enumerated as the causal graph. As illustrated on the left side in FIG. 1, the causal DAG is a directed graph without a cycle (loop). As illustrated on the right side in FIG. 1, a graph with a cycle is not a DAG.

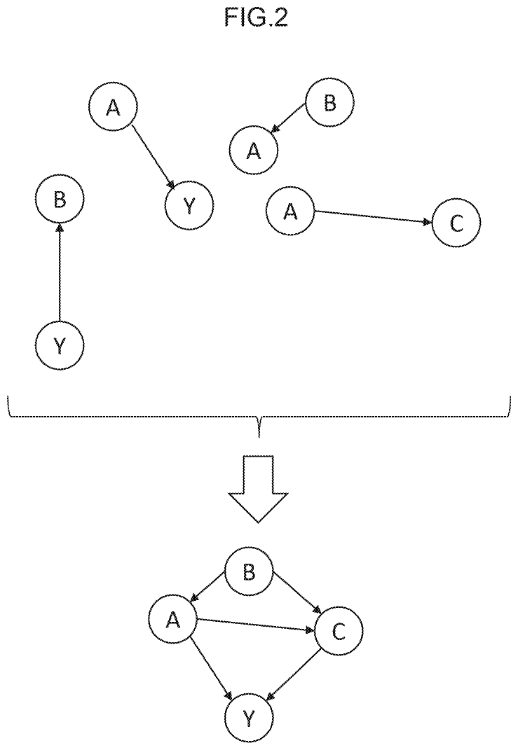

In generation of the causal DAG, whether or not there is a relationship between two variables is estimated, and when there is a relationship between two variables, a direction of an arrow connecting the variables is estimated. Then, such estimation is performed between one-to-many variables, and a plausible direction is determined to restore the entire DAG. In the related art, as illustrated in FIG. 2, directions of arrows connecting two variables are estimated, and one plausible causal DAG is identified based on a combination of the directions.

However, a relationship between the variable A and the variable Y cannot be known unless the directions of the arrows connecting the variables can be specified for all combinations between the variables. In addition, as illustrated in FIG. 2, in the case of narrowing down the directions between two variables first and restoring the entire DAG, it may not be possible to find all possible causal DAGs.

A case of enumerating all the possible causal DAGs rather than finding one plausible causal DAG is also considered. In this case, since the number of combinations of all directions between two variables is exponential, a computational load becomes enormous to exhaustively enumerate all possible causal DAGs.

Further, in many cases, the causal relationship between two variables, that is, a direction of an arrow connecting the two variables is unclear, and only the presence of a relationship between the two variables such as the presence of a correlation between the two variables is known. For example, a direction of a causal relationship between “temperature” and “ice cream sales” is known, but a direction of a causal relationship between “ice cream sales” and “beer sales” is not known. Such a case is an example in which it is unclear whether the beer sales have increased because the temperature is high, or the beer sales have increased because people buy beer while purchasing ice cream for their children.

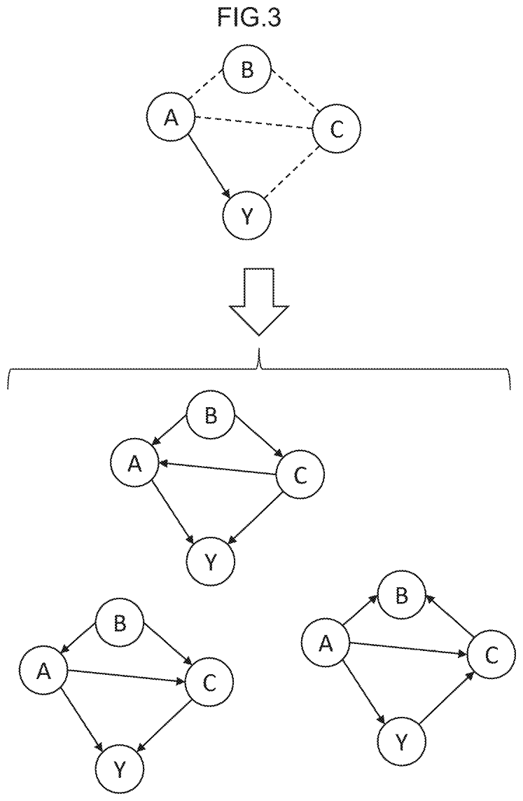

Therefore, in the present embodiment, as illustrated in FIG. 3, all the possible causal DAGs are output from a state in which the presence or absence of a relationship between two variables, and two variables of interest with respect to a causal relationship are known. At this time, in the present embodiment, a computational cost for enumerating the causal DAGs is reduced by using a DAG constraint that there is no cycle. In FIG. 3, an edge indicated by a broken line represents that only the presence of a relationship between two variables connected by the edge is known. The same applies to the following drawings. Hereinafter, an information processing apparatus according to the present embodiment will be described in detail.

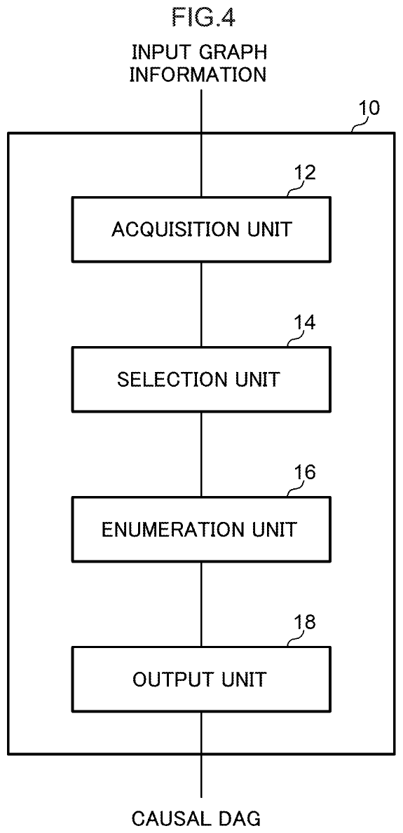

As illustrated in FIG. 4, an information processing apparatus 10 according to the present embodiment functionally includes an acquisition unit 12, a selection unit 14, an enumeration unit 16, and an output unit 18.

The acquisition unit 12 acquires input graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge. Hereinafter, the two variables of interest with respect to the causal relationship are referred to as “variables of interest”.

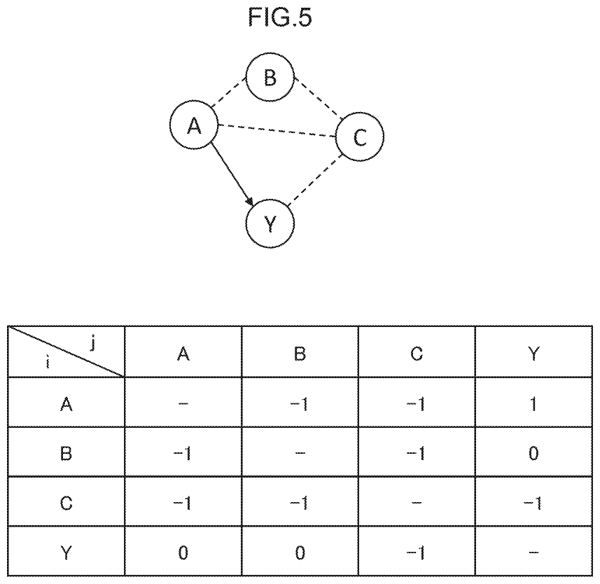

An example of the input graph information is illustrated on the upper side in FIG. 5. In the example illustrated on the upper side in FIG. 5, the variables of interest are the variable A and the variable Y, in which the variable A is a causal variable and the variable Y is a result variable. The variables A and B, the variables A and C, the variables B and C, and the variables C and Y are variables that have a relationship but whose causal relationship is unknown. Hereinafter, a relationship between the causal variable (for example, “A”) and the result variable (for example, “Y”) is expressed as “causal variable→result variable (for example, “A→Y”)”. In addition, a relationship between the variables that have a relationship but whose causal relationship is unknown (for example, “between the variables A and B”) is expressed as “variable-variable (for example, “A-B”)”.

The input graph information is generated by estimating the presence or absence of a relationship between two respective variables and a direction of a causal relationship in a case where the two variables have a relationship. For example, for a variable i and a variable j, the presence or absence of a relationship between the variable i and the variable j and a direction of a causal relationship are estimated by comparing a case of predicting the variable j using the variable i with a case of predicting the variable i using the variable j. For example, prediction accuracy in the former case is P(i→j), prediction accuracy in the latter case is P(j→i), and a threshold is TH. In this case, in a case where P(i→j)>TH and P(j→i)≤TH, the causal relationship between the two variables is estimated as “i→j”, and in a case where P(j→i)>TH and P(i→j)≤TH, the causal relationship between the two variables is estimated as “j→i”. In addition, in a case where P(i→j)>TH and P(j→i)>TH, it is estimated that the two variables have a relationship but a causal relationship therebetween is unknown, and the relationship is estimated as “i-j”, and in a case where P(j→i)≤TH and P(i→j)≤TH, it is estimated that the two variables do not have a relationship. A method of estimating the presence or absence of a relationship between two variables and a direction of a causal relationship is not limited to the above example.

Each of the input graph information, a pattern described below, and the causal DAG may be held as, for example, information in a table format in which a variable is associated with each of a row and a column. An example of information in a table format held as the input graph information illustrated on the upper side in FIG. 5 is illustrated on the lower side in FIG. 5. In the example illustrated on the lower side in FIG. 5, a connection state from the variable i corresponding to the row to the variable j corresponding to the column is illustrated. Specifically, in cells of i rows and j columns, in a case where i→j, that is, in a case where there is a directed edge in a direction from the variable i to the variable j, a value of “1” is set. In a case where j→i or there is no connection, a value of “0” is set. In a case where i-j, that is, in a case where there is an undirected edge between the variable i and the variable j, a value of “−1” is set.

FIG. 5 illustrates an example in which a causal relationship between variables other than the variables of interest (A→Y) is unknown, in other words, an edge other than the edge between the variables A and Y is an undirected edge. However, in a case where there are variables whose causal relationship is known, other than the variables of interest, an edge between the variables may also be a directed edge.

The selection unit 14 selects, in the input graph information acquired by the acquisition unit 12, the shortest path including an undirected edge, the shortest path being a path from the causal variable among the variables of interest to the result variable among the variables of interest via a variable other than the variables of interest. For example, in the case of the input graph information illustrated on the upper side in FIG. 5, the selection unit 14 selects A-C-Y as the shortest path for the variables of interest A→Y.

The enumeration unit 16 enumerates patterns in which the undirected edge included in the shortest path selected by the selection unit 14 is set to a directed edge of a possible direction under the constraint that no cycle is generated between the variables connected by the directed edge.

For example, in the example illustrated on the upper side in FIG. 5, the enumeration unit 16 enumerates a pattern in which a directed edge of A→C is set and a pattern in which a directed edge of C→A is set for an undirected edge between A and C. For example, in a case where a directed edge of Y→C has already been set between C and Y, the enumeration unit 16 excludes the pattern in which the directed edge of C→A is set under the constraint that no cycle is generated, and enumerates the pattern in which the directed edge of A→C is set.

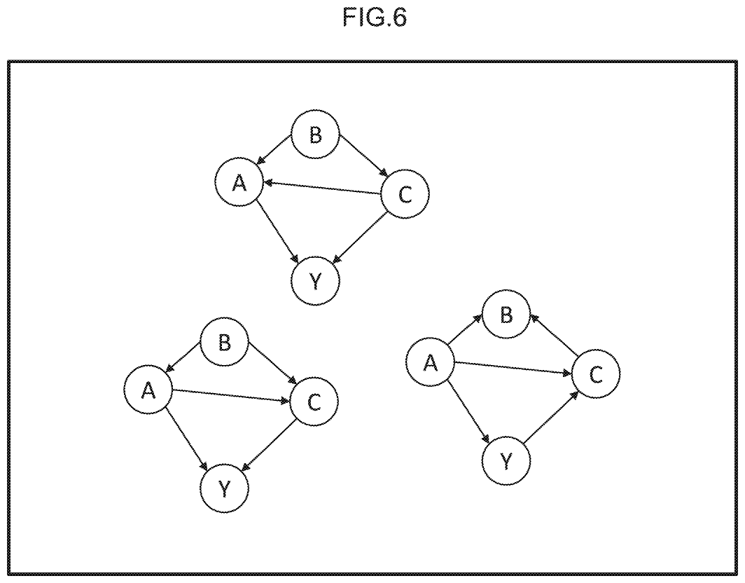

The output unit 18 repeatedly performs selection of the shortest path by the selection unit 14 and enumeration of the patterns by the enumeration unit 16 until there is no undirected edge in the enumerated patterns. The output unit 18 outputs, as the causal DAG, a pattern enumerated when there is no undirected edge in the enumerated pattern. For example, as illustrated in FIG. 6, the output unit 18 displays an output screen in which the causal DAGs are enumerated on a display device.

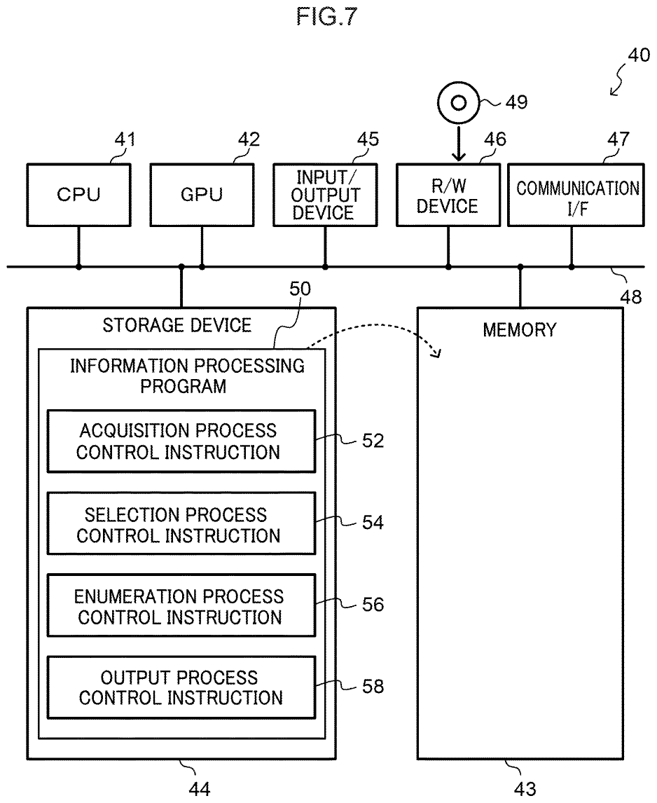

The information processing apparatus 10 may be implemented by, for example, a computer 40 illustrated in FIG. 7. The computer 40 includes a central processing unit (CPU) 41, a graphics processing unit (GPU) 42, a memory 43 serving as a temporary storage area, and a nonvolatile storage device 44. In addition, the computer 40 includes an input/output device 45 such as an input device and a display device, and a read/write (R/W) device 46 that controls reading and writing of data with respect to a storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), or a flash memory. The storage device 44 serving as a storage medium stores an information processing program 50 for causing the computer 40 to function as the information processing apparatus 10. The information processing program 50 includes an acquisition process control instruction 52, a selection process control instruction 54, an enumeration process control instruction 56, and an output process control instruction 58.

The CPU 41 reads the information processing program 50 from the storage device 44, loads the information processing program 50 onto the memory 43, and sequentially executes the control instructions included in the information processing program 50. The CPU 41 operates as the acquisition unit 12 illustrated in FIG. 4 by executing the acquisition process control instruction 52. The CPU 41 operates as the selection unit 14 illustrated in FIG. 4 by executing the selection process control instruction 54. The CPU 41 operates as the enumeration unit 16 illustrated in FIG. 4 by executing the enumeration process control instruction 56. The CPU 41 operates as the output unit 18 illustrated in FIG. 4 by executing the output process control instruction 58. As a result, the computer 40 executing the information processing program 50 functions as the information processing apparatus 10. The CPU 41 that executes the program is hardware. Further, a part of the program may be executed by the GPU 42.

The functions implemented by the information processing program 50 may be implemented by, for example, a semiconductor integrated circuit, more specifically, an application specific integrated circuit (ASIC), a field-programmable gate array (FPGA), or the like.

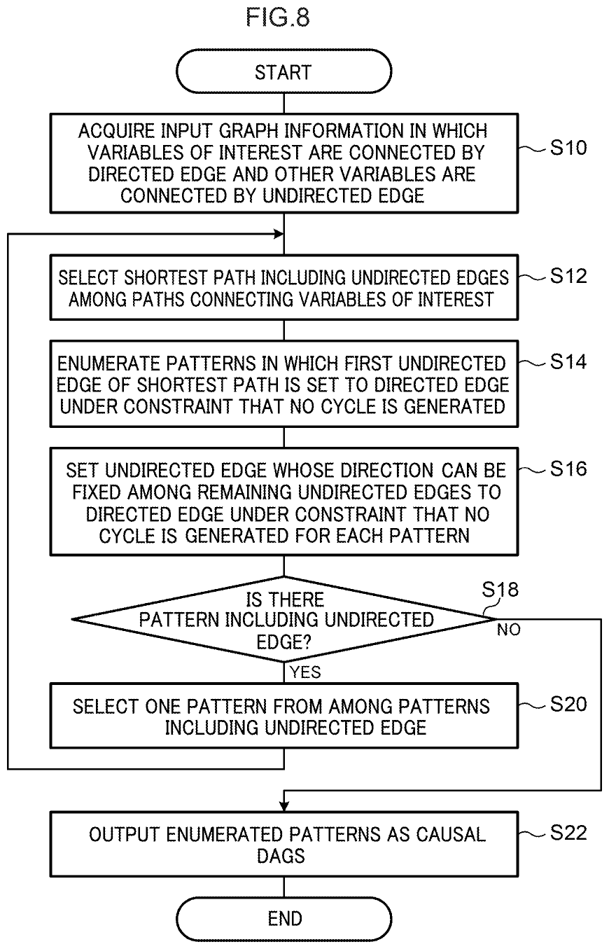

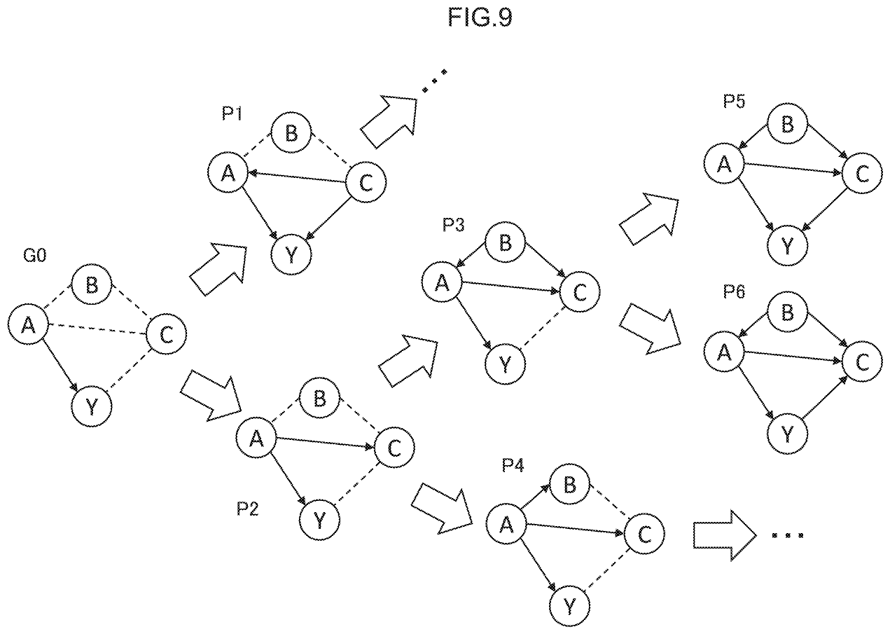

Next, an operation of the information processing apparatus 10 according to the present embodiment will be described. When the input graph information is input to the information processing apparatus 10 and enumeration of the causal DAGs is instructed, the information processing apparatus 10 executes an information processing routine illustrated in FIG. 8. Hereinafter, the information processing routine illustrated in FIG. 8 will be described together with a diagram for describing information processing illustrated in FIG. 9. The information processing routine is an example of an information processing method of the disclosed technology.

In step S10, the acquisition unit 12 acquires input graph information in which, for a plurality of variables, variables that have a causal relationship are connected by a directed edge, variables that have a relationship but whose causal relationship is unknown are connected by an undirected edge, and at least variables of interest are connected by a directed edge. For example, as illustrated in FIG. 9, the acquisition unit 12 acquires input graph information G0 including a directed edge A→Y between the variables of interest and undirected edges A-B, A-C, B-C, and C-Y.

Next, in step S12, the selection unit 14 selects, in the input graph information G0, the shortest path including undirected edge, the shortest path being a path from the causal variable among the variables of interest to the result variable among the variables of interest via a variable other than the variables of interest. In the example of FIG. 9, the selection unit 14 selects A-C-Y as the shortest path.

Next, in step S14, the enumeration unit 16 specifies an undirected edge that is included in the shortest path and that first appears in the shortest path in the order of A→Y between the variables of interest. In addition, the enumeration unit 16 enumerates patterns in which the specified undirected edge is set to a directed edge of each possible direction under the constraint that no cycle is generated between the variables connected by the directed edge. In the example of FIG. 9, the enumeration unit 16 specifies A-C as the first undirected edge in the shortest path. Since the constraint that no cycle is generated is not violated regardless of whether A-C is set to a directed edge A→C or a directed edge C→A, the enumeration unit 16 enumerates a pattern P1 in which the directed edge C→A is set and the pattern P2 in which the directed edge A→C is set.

Next, in step S16, the enumeration unit 16 sets an undirected edge whose direction can be fixed among the remaining undirected edges to a directed edge under the constraint that no cycle is generated for each pattern. In the example of FIG. 9, in a case where C-Y of the pattern P1 is set to Y→C, a cycle of A→Y→C→A is generated. Therefore, the enumeration unit 16 sets C-Y to C→Y. In the case of the pattern P2, since neither C→Y nor Y→C violates the constraint that no cycle is generated, the direction of the directed edge is not fixed here.

Next, in step S18, the output unit 18 determines whether or not there is a pattern including an undirected edge. In a case where there is a pattern including an undirected edge, the processing proceeds to step S20. In step S20, the output unit 18 selects one pattern from among patterns including an undirected edge, and the processing returns to step S12.

Returning to step S12, the selection unit 14 repeats the processing of selecting the shortest path for the pattern selected in step S20. At this time, the selection unit 14 may select the shortest path excluding the previously selected shortest path. For example, in a case where the pattern P2 is selected in step S20, the selection unit 14 selects A-B-C-Y as the shortest path.

Next, in step S14, the enumeration unit 16 specifies A-B as the first undirected edge of the shortest path, and enumerates a pattern P3 in which a directed edge of B→A is set and a pattern P4 in which a directed edge of A→B is set. Next, in step S16, the enumeration unit 16 sets a directed edge B→C whose direction can be fixed under the constraint that no cycle is generated for the pattern P3.

Next, when the pattern P3 is selected in step S20, the processing returns to step S12, and the selection unit 14 selects A-C-Y as the shortest path. Next, in step S14, the enumeration unit 16 specifies C-Y as the first undirected edge of the shortest path, and enumerates a pattern P5 in which a directed edge of C→Y is set and a pattern P6 in which a directed edge of Y→C is set.

As described above, the selection of the shortest path and the enumeration of the patterns are repeated, and in a case where it is determined in step S18 that there is no pattern including an undirected edge, the processing proceeds to step S22. In step S22, the output unit 18 outputs the enumerated patterns as the causal DAGs, and the information processing routine ends.

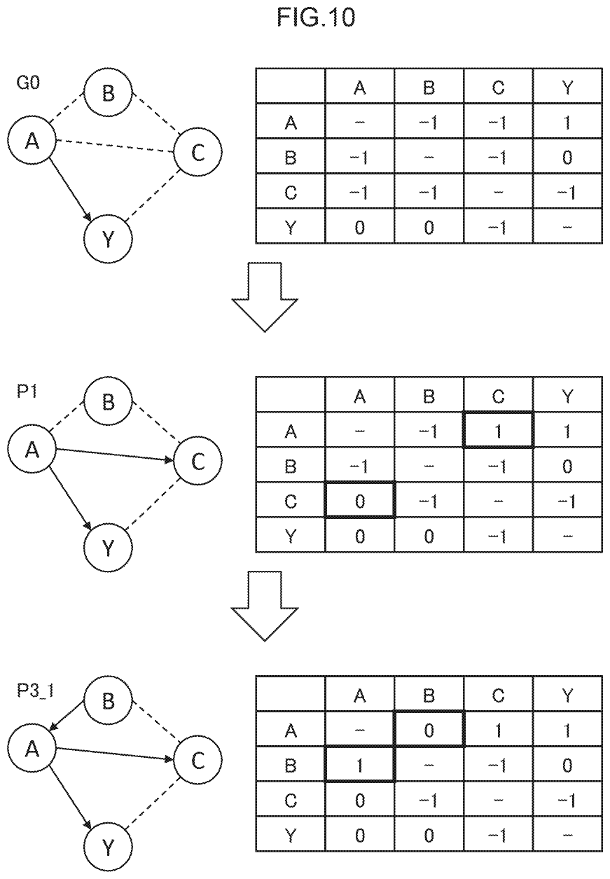

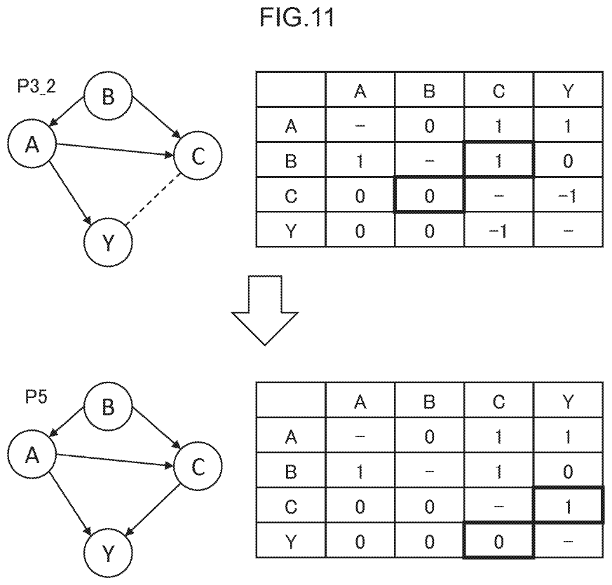

In the example of FIG. 9, a transition of information in a table format in a case where the causal DAG is generated by a transition of input graph information G0→pattern P1→pattern P3→pattern P5 will be described with reference to FIGS. 10 and 11.

As illustrated on the upper side in FIG. 10, it is assumed that information in a table format is held for the input graph information G0. Next, in the case of the pattern P1 in which the directed edge A→C is set, in the information in the table format, a cell of a row A and a column C is updated to “1”, and a cell of a row C and a column A is updated to “0” as illustrated on the middle side of FIG. 10. Next, in the case of a pattern P3_1 in which the directed edge B→A is set, in the information in the table format, a cell of a row B and the column A is updated to “1” and a cell of the row A and a column B is updated to “0” as illustrated on the lower side in FIG. 10.

Next, in the case of a pattern P3_2 in which the directed edge B→C is set, in the information in the table format, a cell of the row B and the column C is updated to “1” and a cell of the row C and the column B is updated to “0” as illustrated on the upper side in FIG. 11. Next, in the case of the pattern P5 in which the directed edge C→Y is set, in the information in the table format, a cell of the row C and a column Y is updated to “1” and a cell of a row Y and the column C is updated to “0” as illustrated on the lower side in FIG. 11. The pattern P5 is one of the enumerated causal DAGs.

As described above, the information processing apparatus according to the present embodiment acquires the input graph information. The input graph information is a graph in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge. Furthermore, the information processing apparatus selects, in the input graph information, the shortest path including undirected edge, the shortest path being a path from a causal variable among two variables of interest to a result variable among two variables of interest via a variable other than the variables of interest. In addition, the information processing apparatus enumerates patterns in which the undirected edge included in the shortest path is set to a directed edge under the constraint that no cycle is generated between the variables connected by the directed edge. Then, the information processing apparatus repeats the selection of the shortest path and the enumeration of the patterns until there is no undirected edge in the enumerated patterns. In this manner, it is possible to reduce the computational cost for enumerating possible causal graphs by enumerating patterns in which an undirected edge is set to a directed edge while excluding a pattern violating the constraint that no cycle is generated.

### First Modified Example

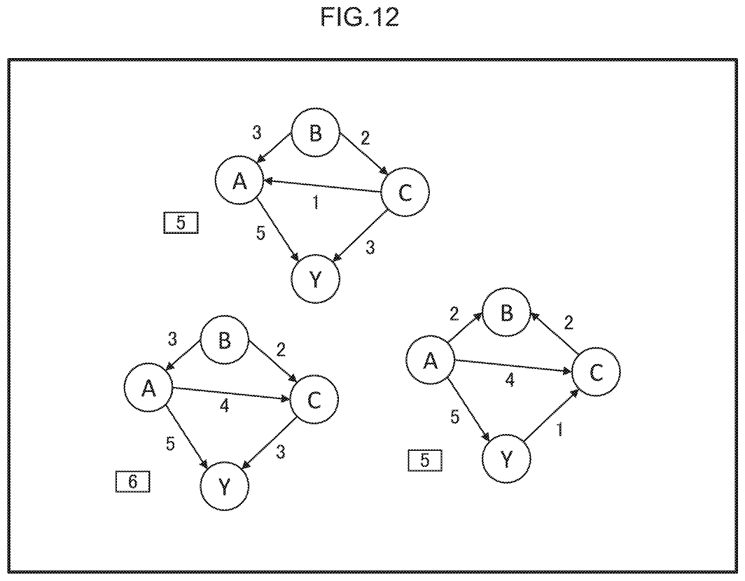

In the above embodiment, a case of outputting the enumerated causal DAGs has been described, but in a first modified example, information regarding a strength of a causal relationship between variables connected at each directed edge is assigned to each directed edge of a causal DAG and output. As the strength of the causal relationship, for example, prediction accuracy calculated at the time of estimating the presence or absence of a relationship between two variables and a direction of a causal relationship in a case where the two variables have a relationship in the input graph information described above may be used. In this case, as illustrated in FIG. 12, the output unit 18 may also output information indicating the strength of the causal relationship for each directed edge of the causal DAG. Furthermore, an average strength of the causal relationship assigned to each directed edge included in a path connecting variables of interest may also be written and output for each causal DAG.

### Second Modified Example

In the above embodiment, in the information processing routine illustrated in FIG. 8, when the processing returns from step S20 to step S12, the shortest path is selected in step S12 except for the previously selected shortest path. In a second modified example, the shortest path is selected without excluding the previously selected shortest path.

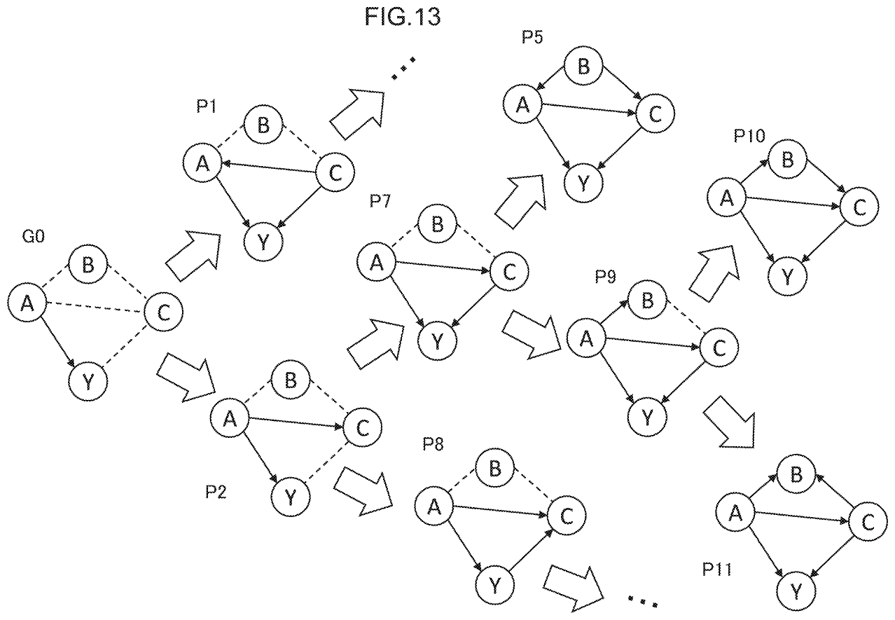

In this case, as illustrated in FIG. 13, when the pattern P2 is selected in step S20 and the processing returns to step S12, A→C-Y is selected as the shortest path. In this case, patterns P7 and P8 in which the first undirected edge C-Y included in the shortest path is set to a directed edge are enumerated. Then, in a case where the pattern P7 is selected, the shortest path A-B-C→Y is selected, and patterns P5 and P9 in which the first undirected edge A-B is set to a directed edge are enumerated. Similarly, patterns P10, and P11 are enumerated based on the pattern P9.

In the above embodiment, the information processing program is stored (installed) in the storage device in advance, but the disclosed technology is not limited thereto. The program according to the disclosed technology may be provided in a form of being stored in a storage medium such as a CD-ROM, a DVD-ROM, or a USB memory.

Providing a single causal graph as a result of investigating a causal relationship between a plurality of events to a user may result in missing useful information regarding the causal relationship. In addition, new knowledge may be found by enumerating and observing not only the optimal causal graph but also other possible causal graphs. In this regard, it is assumed to list all possible causal graphs.

However, in this case, it is necessary to exhaustively repeat processing of creating one optimal causal graph and excluding the causal graph and then creating the next optimal causal graph, and there is a problem in that a computational cost for enumerating the possible causal graphs increases.

As one aspect, there is an effect that a computational cost for enumerating possible causal graphs can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

10 Information processing apparatus
12 Acquisition unit
14 Selection unit
16 Enumeration unit
18 Output unit
40 Computer
41 CPU
42 GPU
43 Memory
44 Storage device
45 Input/output device
46 R/W device
47 Communication I/F
48 Bus
49 Storage medium
50 Information processing program
52 Acquisition process control instruction
54 Selection process control instruction
56 Enumeration process control instruction
58 Output process control instruction

1. A non-transitory recording medium storing a program executable by a computer to perform information processing comprising:
acquiring graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge;
selecting, in the graph information, a shortest path including the undirected edge, the shortest path being a path from a causal variable among the two variables of interest to a result variable among the two variables of interest via a variable other than the two variables of interest;
enumerating patterns in which the undirected edge included in the shortest path is set to a directed edge under a constraint that no cycle is generated between the variables connected by the directed edge; and
repeating the selecting the shortest path and the enumerating patterns until no undirected edge remains in the enumerated patterns.

2. The non-transitory recording medium of claim 1, the information processing further comprising outputting, as a causal relationship graph, a pattern enumerated at a stage at which no undirected edges remain.

3. The non-transitory recording medium of claim 2, wherein the outputting the causal relationship graph includes assigning and outputting, for each directed edge included in the causal relationship graph, information regarding a strength of the causal relationship between the variables connected by the directed edge.

4. An information processing method, comprising:
by a processor,
acquiring graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge;
selecting, in the graph information, a shortest path including the undirected edge, the shortest path being a path from a causal variable among the two variables of interest to a result variable among the two variables of interest via a variable other than the two variables of interest;
enumerating patterns in which the undirected edge included in the shortest path is set to a directed edge under a constraint that no cycle is generated between the variables connected by the directed edge; and
repeating the selecting the shortest path and the enumerating patterns until no undirected edge remains in the enumerated patterns.

5. The information processing method of claim 4, wherein the processor executes processing of outputting, as a causal relationship graph, a pattern enumerated at a stage at which no undirected edges remain.

6. The information processing method of claim 5, wherein the outputting the causal relationship graph includes assigning and outputting, for each directed edge included in the causal relationship graph, information regarding a strength of the causal relationship between the variables connected by the directed edge.

7. An information processing apparatus, comprising:
a memory; and
a processor coupled to the memory, the processor being configured to execute processing including:
acquiring graph information in which, for a plurality of variables, variables that have a causal relationship are connected by a directed edge, variables that have a relationship but whose causal relationship is unknown are connected by an undirected edge, and at least two variables of interest with respect to a causal relationship are connected by a directed edge;
selecting, in the graph information, a shortest path including the undirected edge, the shortest path being a path from a causal variable among the two variables of interest to a result variable among the two variables of interest via a variable other than the two variables of interest;
enumerating patterns in which the undirected edge included in the shortest path is set to a directed edge under a constraint that no cycle is generated between the variables connected by the directed edge; and
repeating the selecting the shortest path and the enumerating patterns until no undirected edge remains in the enumerated patterns.

8. The information processing apparatus of claim 7, wherein the processor executes processing of outputting, as a causal relationship graph, a pattern enumerated at a stage at which no undirected edges remain.

9. The information processing apparatus of claim 8, wherein the outputting the causal relationship graph includes assigning and outputting, for each directed edge included in the causal relationship graph, information regarding a strength of the causal relationship between the variables connected by the directed edge.
